(19) United States
(12) Patent Application Publication
(10) Pub. No.: US 2026/0253112 A1
(43) Pub. Date: Aug. 27, 2026

(54) COST FUNCTION GENERATION DEVICE, PROCESSING DEVICE, COST FUNCTION GENERATION METHOD, AND COST FUNCTION GENERATION PROGRAM

(71) Applicant: GRID INC., Tokyo (JP)

(72) Inventors: Chih-chieh CHEN, Tokyo (JP); Masaru SOGABE, Tokyo (JP); Kodai SHIBA, Tokyo (JP); Keita TAKAHASHI, Tokyo (JP)

(21) Appl. No.: 19/644,846

(22) Filed: Apr. 10, 2026

Related U.S. Application Data
(63) Continuation of application No. PCT/JP2024/035469, filed on Oct. 3, 2024.
(60) Provisional application No. 63/589,832, filed on Oct. 12, 2023.

(30) Foreign Application Priority Data
Apr. 24, 2024 (JP) 2024-70246

(51) Int. Cl. G06Q 30/0283; G06Q 50/06

(52) U.S. Cl. CPC G06Q 30/0283; G06Q 50/06

(57) ABSTRACT

A cost function generation device includes: a parameter information acquisition unit that acquires parameter information including N (an integer equal to or more than 1) as a parameter; and a function generation unit that generates, based on the parameter information, a cost function including plural binary variables for calculating a unit commitment schedule for plural power generating units over plural consecutive time frames by quadratic unconstrained binary optimization, wherein the cost function includes the amount of power generation in each of the time frames and each of the power generating units, the plural binary variables include N first binary variables in each of the time frames and each of the power generating units, and the amount of power generation is expressed using any one of 2^{N} patterns with the N first binary variables.

### CROSS-REFERENCE TO RELATED APPLICATIONS

This application is a continuation application of International Patent Application No. PCT/JP2024/035469, filed on Oct. 3, 2024, which claims the benefit of, and priority to U.S. Provisional Patent Application No. 63/589,832 filed on Oct. 12, 2023, and Japanese Patent Application No. 2024-70246 filed on Apr. 24, 2024, the entire contents of which are incorporated herein by reference.

### TECHNICAL FIELD

The present disclosure relates to a cost function generation device, a processing device, a cost function generation method, and a cost function generation program.

### Background Art

A unit commitment problem (UCP) is a model for optimizing power generating units in a power grid. The UCP may be formulated in the form of quadratic unconstrained binary optimization (QUBO) (for example, Non-Patent Literature 1).

### SUMMARY OF INVENTION

In the method described in Non-Patent Literature 1, the amount of power generation of a power generating unit is expressed using any one of N+1 patterns with N+1 binary variables. Therefore, this is not desirable because many binary variables are required and hence the computational cost increases.

Thus, it is an object of the present disclosure to provide a cost function generation device, a processing device, a cost function generation method, and a cost function generation program capable of expressing the amount of power generation with fewer binary variables.

A cost function generation device according to one aspect of the present invention includes: a parameter information acquisition unit that acquires parameter information including N (an integer equal to or more than 1) as a parameter; and a function generation unit that generates, based on the parameter information, a cost function including a plurality of binary variables for calculating a unit commitment schedule for a plurality of power generating units over a plurality of consecutive time frames by quadratic unconstrained binary optimization, wherein the cost function includes the amount of power generation in each of the time frames and each of the power generating units, the plurality of binary variables include N first binary variables in each of the time frames and each of the power generating units, and the amount of power generation is expressed using any one of 2^{N} patterns with the N first binary variables.

Thus, the amount of power generation can be expressed with fewer binary variables by such a composition that 2^{N} amounts of power generation are expressed with N first binary variables.

The above aspect may be such that
the parameter information includes H and U as parameters,
the plurality of binary variables include aᵢ^{t,t} as a second binary variable, and
the cost function includes the following Equation (1) as a first constraint term:

$$\begin{matrix}[ Math . 1 ] & \\ {Q}_{1} = {\sum }_{t = 0}^{H - 1} {\sum }_{i = 0}^{U - 1} ( 1 - {a}_{i}^{t , t} ) ( {\sum }_{k = 1}^{N} {z}_{i k}^{t} ) & ( 1 )\end{matrix}$$

where H and U are the number of time frames and the number of power generating units, respectively,
t and i are indexes of one of the time frames and one of the power generating units, respectively,
aᵢ^{t,t} indicates either an ON state or an OFF state of the power generating unit with index i in the time frame with index t,
k is an index, and
zᵢₖ^{t} is the first binary variable.

According to this aspect, when the second binary variable aᵢ^{t,t} indicates ON, since (1-aᵢ^{t,t}) becomes zero, Σₖ₌₁^{N}zᵢₖ^{t} is not reflected in the cost function whatever the value is. On the other hand, when the second binary variable aᵢ^{t,t} indicates OFF, since (1-aᵢ^{t,t}) becomes 1, Σₖ₌₁^{N}zᵢₖ^{t} is reflected in the cost function. Therefore, Σₖ₌₁^{N}zᵢₖ^{t} can be optimized to be close to zero in the process of optimization. Thus, the first binary variable zᵢₖ^{t} and the second binary variable aᵢ^{t,t} that meet upper and lower limit constraints on the output of the power generating unit can be found.

The above aspect may also be such that
the parameter information includes H, U, Lₜ, P_{max,i}, and P_{min,i} as parameters,
the plurality of binary variables include aᵢ^{t,t} as a second binary variable, and
the cost function includes the following Equation (2) as a second constraint term:

$$\begin{matrix}[ Math . 2 ] & \\ {Q}_{2} = {\sum }_{t = 0}^{H - 1} {\{ {L}_{t} - {\sum }_{i = 0}^{U - 1} [ ( {P}_{max , i} - {P}_{min , i} ) ( {\sum }_{k = 1}^{N} {2}^{- k} {z}_{ik}^{t} ) + {P}_{min , i} {a}_{i}^{t , t} ] \}}^{2} & ( 2 )\end{matrix}$$

where H and U are the number of time frames and the number of power generating units, respectively,
t and i are indexes of one of the time frames and one of the power generating units, respectively,
aᵢ^{t,t} indicates either an ON state or an OFF state of the power generating unit with index i in the time frame with index t,
k is an index,
zᵢₖ^{t} is the first binary variable,
Lₜ is a power demand in the time frame with index t, and
P_{max,i} and P_{min,i} are the maximum power generation and the minimum power generation of the power generating unit with index i, respectively.

According to this aspect, the first binary variable zᵢₖ^{t} can be so optimized that the total amount of power generation of the plurality of power generating units and the power demand Lₜ get close to being balanced in each time frame. Thus, the first binary variable zᵢₖ^{t} and the second binary variable aᵢ^{t,t} that meet a supply-demand balance constraint can be found.

The above aspect may further be such that
the parameter information includes H, U, Lₜ, P_{max,i}, Rₜ, and F as parameters,
the plurality of binary variables include aᵢ^{t,t} and ψₖ^{t} as a second binary variable and a third binary variable, respectively, and
the cost function includes the following Equation (3) as a third constraint term:

$$\begin{matrix}[ Math . 3 ] & \\ {Q}_{3} = {\sum }_{t = 0}^{H - 1} {\{ {\sum }_{i = 0}^{U - 1} {P}_{max , i} {a}_{i}^{t , t} - {L}_{t} - {R}_{t} - [ {\sum }_{i = 0}^{U - 1} {P}_{max , i} - {L}_{t} - {R}_{t} ] ( {\sum }_{k = 1}^{F} {2}^{- k} {ψ}_{k}^{t} ) \}}^{2} & ( 3 )\end{matrix}$$

where H and U are the number of time frames and the number of power generating units, respectively,
t and i are indexes of one of the time frames and one of the power generating units, respectively,
aᵢ^{t,t} indicates either an ON state or an OFF state of the power generating unit with index i in the time frame with index t,
F is an integer equal to or more than 1,
k is an index,
Lₜ is a power demand in the time frame with index t,
P_{max,i} is the maximum power generation of the power generating unit with index i, and
Rₜ is a spinning reserve in the time frame with index t.

Since Σᵢ₌₀^{U-1}P_{max,i}aᵢ^{t,t} is equal to or less than Σᵢ₌₀^{U-1}P_{max,i}, when Σᵢ₌₀^{U-1}P_{max,i}aᵢ^{t,t} is equal to or more than Lₜ+Rₜ in each time frame, the third binary variable ψₖ^{t} to make Q3 close to zero exists. Therefore, the second binary variable aᵢ^{t,t} and the third binary variable ψₖ^{t} can be so optimized that Q3 is close to zero in each time frame in the process of optimization. Thus, the second binary variable aᵢ^{t,t} and the third binary variable ψₖ^{t} that meet a spinning reserve constraint can be found.

Further, the above aspect may be such that
the parameter information includes H, U, P_{max,i}, P_{min,i}, P_{up,i}, P_{down,i}, and F as parameters,
the plurality of binary variables include aᵢ^{t,t} and χ_{i,k}^{t} as a second binary variable and a fourth binary variable, respectively, and
the cost function includes the following Equation (4) as a fourth constraint term:

$$\begin{matrix}[ Math . 4 ] & \\ \begin{matrix}{Q}_{4} = {\sum }_{t = 0}^{H - 1} {\sum }_{i = 0}^{U - 1} [ ( {P}_{max , i} - {P}_{min , i} ) ( {\sum }_{k = 1}^{N} {2}^{- k} ( {z}_{1 k}^{t} - {z}_{ik}^{t - 1} ) ) + {P}_{min , i} ( {a}_{i}^{t , t} - {a}_{i}^{t - 1 , t - 1} ) - \\ { {P}_{up , i} + ( {P}_{up , i} + {P}_{down , i} ) {\sum }_{k = 1}^{F} {2}^{- k} {χ}_{i , k}^{t} ]}^{2}\end{matrix} & ( 4 )\end{matrix}$$

where H and U are the number of time frames and the number of power generating units, respectively,
t and i are indexes of one of the time frames and one of the power generating units, respectively,
aᵢ^{t,t} indicates either an ON state or an OFF state of the power generating unit with index i in the time frame with index t,
F is an integer equal to or more than 1,
k is an index,
zᵢₖ^{t} is the first binary variable,
P_{max,i} and P_{min,i} are the maximum power generation and the minimum power generation of the power generating unit with index i, respectively, and
P_{up,i} and P_{down,i} are a power incremental limit value and a power decremental limit value of the power generating unit with index i, respectively.

It is preferable that a value obtained by subtracting the power incremental limit value P_{up,i} from an increase in power generation of the power generating unit with index i over a period from a time frame with index t−1 to the time frame with index t is zero or less. (P_{up,i}+P_{down,i})·Σₖ₌₁F2-kχ_{i,k}^{t} is a positive real number not less than zero and not more than (P_{up,i}+P_{down,i}). Therefore, in the process of optimization, the first binary variable zᵢₖ^{t}, the second binary variable aᵢ^{t,t}, and the fourth binary variable χ_{i,k}^{t} in each time frame and each power generating unit can be so optimized that the value obtained by subtracting the power incremental limit value P_{up,i} from the increase in power generation of the power generating unit with index i over the period from the time frame with index t−1 to the time frame with index t is equal to or less than zero. Thus, the first binary variable zᵢₖ^{t}, the second binary variable aᵢ^{t,t}, and the fourth binary variable χ_{i,k}^{t} that meet a power increase constraint can be found.

Further, the above aspect may be such that
the parameter information includes H, U, P_{max,i}, P_{min,i}, P_{up,i}, P_{down,i}, and F as parameters,
the plurality of binary variables include aᵢ^{t,t} and φ_{i,k}^{t} as a second binary variable and a fifth binary variable, respectively, and
the cost function includes the following Equation (5) as a fifth constraint term:

$$\begin{matrix}[ Math . 5 ] & \\ \begin{matrix}{Q}_{5} = {\sum }_{t = 0}^{H - 1} {\sum }_{i = 0}^{U - 1} [ ( {P}_{max , i} \to {P}_{min , i} ) ( {\sum }_{K = 1}^{N} {2}^{- k} ( {z}_{i k}^{t} - {z}_{i k}^{t - 1} ) ) + {P}_{min , 1} ( {a}_{i}^{t , t} - {a}_{i}^{t - 1 , t - 1} ) + \\ {{P}_{d o w n , i} - ( {P}_{up , i} + {P}_{down , i} ) {\sum }_{k = 1}^{F} {2}^{- k} {ϕ}_{i , k}^{t} ]}^{2}\end{matrix} & ( 5 )\end{matrix}$$

where H and U are the number of time frames and the number of power generating units, respectively,
t and i are indexes of one of the time frames and one of the power generating units, respectively,
aᵢ^{t,t} indicates either an ON state or an OFF state of the power generating unit with index i in the time frame with index t,
F is an integer equal to or more than 1,
k is an index,
zᵢₖ^{t} is the first binary variable,
P_{max,i} and P_{min,i} are the maximum power generation and the minimum power generation of the power generating unit with index i, respectively, and
P_{up,i} and P_{down,i} are a power incremental limit value and a power decremental limit value of the power generating unit with index i, respectively.

It is preferable that a value obtained by adding the power decremental limit value P_{down,i} to an increase in power generation of the power generating unit with index i over a period from a time frame with index t−1 to the time frame with index t is zero or more. (P_{up,i}+P_{down,i})·Σₖ₌₁^{F}2^{-k}φ_{i,k}^{t} is a positive real number not less than zero and not more than (P_{up,i}+P_{down,i}). Therefore, in the process of optimization, the first binary variable zᵢₖ^{t}, the second binary variable aᵢ^{t,t} and the fifth binary variable φ_{i,k}^{t} in each time frame and each power generating unit can be so optimized that the value obtained by adding the power decremental limit value P_{down,i} to the increase in power generation of the power generating unit with index i over the period from the time frame with index t−1 to the time frame with index t is zero or more. Thus, the first binary variable zᵢₖ^{t}, the second binary variable aᵢ^{t,t}, and the fifth binary variable φ_{i,k}^{t} that meet a power decrease constraint can be found.

Further, the above aspect may be such that
the parameter information includes H, U, T_{min,on,i}, T_{on,i}⁻¹, and G as parameters,
the plurality of binary variables include aᵢ^{t,t2} and η_{i,j}^{t} as a sixth binary variable and a seventh binary variable, respectively, and
the cost function includes the following Equation (6) as a sixth constraint term:

$$\begin{matrix}[ Math . 6 ] & \\ {Q}_{6} = {\sum }_{i = 0}^{U - 1} {[ ( {a}_{i}^{- 1 , - 1} - {a}_{i}^{0 , 0} ) ( {T}_{on , i}^{- 1} - {T}_{min , on , i} ) - {\sum }_{j = 0}^{G - 1} {2}^{j} {η}_{i , j}^{0} ]}^{2} + {\sum }_{i = 0}^{U - 1} {\sum }_{t = 1}^{H - 1} {\{ [ {\sum }_{{t}_{2} = 0}^{t - 1} ( {a}_{i}^{t - 1 , {t}_{2}} - {a}_{i}^{t , {t}_{2}} ) ] + ( {a}_{i}^{t - 1 , 0} - {a}_{i}^{t , 0} ) {T}_{on , i}^{- 1} - ( {a}_{i}^{t - 1 , t - 1} - {a}_{i}^{t , t} ) {T}_{min , on , i} - {\sum }_{j = 0}^{G - 1} {2}^{j} {η}_{i , j}^{t} \}}^{2} & ( 6 )\end{matrix}$$

where H and U are the number of time frames and the number of power generating units, respectively,
t and t2 are indexes of ones of the time frames,
i is an index of one of the power generating units,
aᵢ^{t,t2} indicates a product of ON or OFF states of the power generating unit with index i in the respective time frames after the time frame with index t2 and before the time frame with index t,
G is an integer equal to or more than 1,
j is an index,
T_{min,on,i} is a minimum uptime of the power generating unit with index i, and
T_{on,i}⁻¹ is a continuous uptime period of the power generating unit with index i in the time frames with an index being zero.

It is preferable that (aᵢ^{t-1,t-1}-aᵢ^{t,t}) (T_{on,i}^{t-1}-T_{min,on,i}) is an integer equal to or more than zero to meet a minimum uptime constraint on the power generating unit with index i over a period from the time frame with index t−1 to the time frame with index t. Σⱼ₌₀^{G-1}2^{j}η_{i,j}^{t} is an integer equal to or more than zero. Therefore, in the process of optimization, aᵢ^{t,t} and η_{i,j}^{t} in each time frame and each power generating unit can be so optimized that (aᵢ^{t-1,t-1}-aᵢ^{t,t}) (T_{on,i}^{t-1}-T_{min,on,i}) is zero or more. Thus, the sixth binary variable aᵢ^{t,t2} and the seventh binary variable η_{i,j}^{t} that meet the minimum uptime constraint can be found.

Further, the above aspect may be such that
the cost function includes the following Equation (7) as a seventh constraint term:

$$\begin{matrix}[ Math . 7 ] & \\ {Q}_{7} = {\sum }_{0 \leq {t}_{2} < {t}_{1} < H} {\sum }_{i = 0}^{U - 1} [ {a}_{i}^{{t}_{1} , {t}_{1}} {a}_{i}^{{t}_{1} - 1 , {t}_{2}} - 2 ( {a}_{i}^{{t}_{1} , {t}_{1}} {a}_{i}^{{t}_{1} - 1 , {t}_{2}} ) {a}_{i}^{{t}_{1} , {t}_{2}} + 3 {a}_{i}^{{t}_{1} , {t}_{2}} ] & ( 7 )\end{matrix}$$

where t1 is an index of one of the time frames,
aᵢ^{t1,t1} indicates either an ON state or an OFF state of the power generating unit with index i in the time frame with index t1,
aᵢ^{t1-1,t2} indicates a product of ON or OFF states of the power generating unit with index i in the respective time frames after the time frame with index t2 and before a time frame with index t1-1, and
aᵢ^{t1,t2} indicates a product of ON or OFF states of the power generating unit with index i in the respective time frames after the time frame with index t2 and before the time frame with index t1.

According to this aspect, in the case of aᵢ^{t1,t2}≠aᵢ^{t1,t1}·aᵢ^{t1-1,t2}, [aᵢ^{t1,t1}·aᵢ^{t1-1,t2}−2(aᵢ^{t1,t1}+aᵢ^{t1-1,t2})aᵢ^{t1,t2}+3aᵢ^{t1,t2}] gives 1 or 3, while in the case of aᵢ^{t1, t2}=aᵢ^{t1,t1}·aᵢ^{t1-1,t2}, [aᵢ^{t1,t1}·aᵢ^{t1-1,t2}−2 (aᵢ^{t1,t1}+aᵢ^{t1-1,t2})aᵢ^{t1,t2}+3aᵢ^{t1,t2}] gives zero. Therefore, in the process of optimization, valid sixth binary variables aᵢ^{t1,t2}, aᵢ^{t1,t1}, and aᵢ^{t1-1,t2} that meet aᵢ^{t1,t2}-aᵢ^{t1,t1}·aᵢ^{t1-1,t2} in each time frame and each power generating unit can be obtained.

Further, the above aspect may be such that
the parameter information includes P_{max,i} and P_{min,i} as parameters,
the plurality of binary variables include aᵢ^{t,t} as a second binary variable, and
the amount of power generation is expressed in the following Formula (8):

$$\begin{matrix}[ Math . 8 ] & \\ ( {P}_{max , i} - {P}_{min , i} ) ( {\sum }_{k = 1}^{N} {2}^{- k} {z}_{ik}^{t} ) + {P}_{min , i} {a}_{i}^{t , t} & ( 8 )\end{matrix}$$

where t and i are indexes of one of the time frames and one of the power generating units, respectively,
aᵢ^{t,t} indicates either an ON state or an OFF state of the power generating unit with index i in the time frame with index t,
k is an index,
zᵢₖ^{t} is the first binary variable, and
P_{max,i} and P_{min,i} are the maximum power generation and the minimum power generation of the power generating unit with index i, respectively.

According to this aspect, 2^{N} amounts of power generation can be expressed by N first binary variables.

Further, the above aspect may be such that
the parameter information includes H, U, T_{min,off,i}, T_{off,i}⁻¹, and G as parameters,
the plurality of binary variables include bᵢ^{t,t2} and γ_{i,j}^{t} as an eighth binary variable and a ninth binary variable, and
the cost function includes the following Equation (9) as an eighth constraint term:

$$\begin{matrix}[ Math . 9 ] & \\ {Q}_{8} = {\sum }_{i = 0}^{U - 1} {[ ( {b}_{i}^{- 1 , - 1} - {b}_{i}^{0 , 0} ) ( {T}_{off , i}^{- 1} - {T}_{min , off , i} ) - {\sum }_{j = 0}^{G - 1} {2}^{j} {γ}_{i , j}^{0} ]}^{2} + {\sum }_{i = 0}^{U - 1} {\sum }_{t = 1}^{H - 1} {\{ [ {\sum }_{{t}_{2} = 0}^{t - 1} ( {b}_{i}^{t - 1 , {t}_{2}} - {b}_{i}^{t , {t}_{2}} ) ] + ( {b}_{i}^{t - 1 , 0} - {b}_{i}^{t , 0} ) {T}_{off , i}^{- 1} - ( {b}_{i}^{t - 1 , t - 1} - {b}_{i}^{t , t} ) {T}_{min , off , i} - {\sum }_{j = 0}^{G - 1} {2}^{j} {γ}_{i , j}^{t} \}}^{2} & ( 9 )\end{matrix}$$

where H and U are the number of time frames and the number of power generating units, respectively,
t and t2 are indexes of ones of the time frames,
i is an index of one of the power generating units,
bᵢ^{t,t2} indicates a product of ON or OFF states of the power generating unit with index i in the respective time frames after the time frame with index t2 and before the time frame with index t,
G is an integer equal to or more than 1,
j is an index,
T_{min, off,i} is a minimum downtime of the power generating unit with index i, and
T_{off,i}⁻¹ is a continuous downtime period of the power generating unit with index i in the time frames with an index being zero.

It is preferable that (bᵢ^{t-1,t-1}-bᵢ^{t,t}) (T_{off,i}^{t-1}-T_{min,off,i}) is an integer equal to or more than zero to meet a minimum downtime constraint on the power generating unit with index i over a period from the time frame with index t-1 to the time frame with index t. Σⱼ₌₀^{G-1}2^{j}γ_{i,j}^{t} is an integer equal to or more than zero. Therefore, in the process of optimization, bᵢ^{t,t} and γ_{i,j}^{t} in each time frame and each power generating unit can be so optimized that (bᵢ^{t-1,t-1}-bᵢ^{t,t})(T_{off,i}^{t-1}-T_{min,off,i}) is zero or more. Thus, the eighth binary variable bᵢ^{t,t2} and the ninth binary variable γ_{i,j}^{t} that meet the minimum downtime constraint can be found.

Further, the above aspect may be such that
the cost function includes the following Equation (10) as a ninth constraint term:

$$\begin{matrix}[ Math . 10 ] & \\ {Q}_{9} = {\sum }_{0 \leq {t}_{2} < {t}_{1} < H} {\sum }_{i = 0}^{U - 1} [ {b}_{i}^{{t}_{1} , {t}_{1}} {b}_{i}^{{t}_{1} - 1 , {t}_{2}} - 2 ( {b}_{i}^{{t}_{1} , {t}_{1}} {b}_{i}^{{t}_{1} - 1 , {t}_{2}} ) {b}_{i}^{{t}_{1} , {t}_{2}} + 3 {b}_{i}^{{t}_{1} , {t}_{2}} ] & ( 10 )\end{matrix}$$

where t1 is an index of one of the time frames,
bᵢ^{t1,t1} indicates either an ON state or an OFF state of the power generating unit with index i in the time frame with index t1,
bᵢ^{t1-1,t2} indicates a product of OFF or ON states of the power generating unit with index i in the respective time frames after the time frame with index t2 and before a time frame with index t1-1, and
bᵢ^{t1,t2} indicates a product of OFF or ON states of the power generating unit with index i in the respective time frames after the time frame with index t2 and before the time frame with index t1.

According to this aspect, in the case of bᵢ^{t1,t2}≠bᵢ^{t1,t1}·bᵢ^{t1-1,t2}, [bᵢ^{t1,t1}·bᵢ^{t1-1,t2}−2 (bᵢ^{t1,t1}+bᵢ^{t1-1,t2})bᵢ^{t1,t2}+3bᵢ^{t1,t2}] gives 1 or 3, while in the case of bᵢ^{t1,t2}=bᵢ^{t1,t1}·bᵢ^{t1-1,t2} [bᵢ^{t1,t1}·bᵢ^{t1-1,t2}−2 (bᵢ^{t1,t1}+bᵢ^{t1-1,t2})bᵢ^{t1,t2}+3bᵢ^{t1,t2}] gives zero. Therefore, in the process of optimization, valid eighth binary variables bᵢ^{t1,t2}, bᵢ^{t1,t1}, and bᵢ^{t1-1,t2} that meet bᵢ^{t1,t2}=bᵢ^{t1,t1}·bᵢ^{t1-1,t2} in each time frame and each power generating unit can be obtained.

Further, the above aspect may be such that
the plurality of binary variables include bᵢ^{t,t} as a tenth binary variable, and
the cost function includes the following Equation (11) as a tenth constraint term:

$$\begin{matrix}[ Math . 11 ] & \\ {Q}_{10} = {\sum }_{t = 0}^{H - 1} {\sum }_{i = 0}^{U - 1} {[ {a}_{i}^{t , t} + {b}_{i}^{t , t} - 1 ]}^{2} & ( 11 )\end{matrix}$$

where aᵢ^{t,t} indicates either an ON state or an OFF state of the power generating unit with index i in the time frame with index t, and
bᵢ^{t,t} indicates either the ON state or the OFF state of the power generating unit with index i in the time frame with index t.

According to this aspect, when aᵢ^{t,t} and bᵢ^{t,t} are both 1 or zero, [aᵢ^{t,t}+bᵢ^{t,t}−1]² gives 1, while when either one of aᵢ^{t,t} and bᵢ^{t,t} is 1 and the other is zero, [aᵢ^{t,t}+bᵢ^{t,t}−1]² gives zero. Therefore, in the process of optimization, valid second binary variable aᵢ^{t,t} and tenth binary variable bᵢ^{t,t} as complementary logic variables, one of which is 1 and the other is zero, can be obtained in each time frame and each power generating unit.

A processing device according to another aspect of the present invention includes the above cost function generation device, and a quantum computer unit that optimizes the plurality of binary variables to reduce costs based on the cost function.

Thus, the amount of power generation can be expressed with fewer binary variables by such a composition that 2^{N} amounts of power generation are expressed with N first binary variables. Then, a unit commitment schedule for power generating units, which meets constraint conditions and reduces costs, can be obtained efficiently by such a composition that a cost function with traditional costs and constraint conditions in the UCP represented therein is generated in a form suitable for optimization by the quantum computer unit, and a plurality of binary variables are optimized by the quantum computer unit.

A cost function generation method according to still another aspect of the present invention is a cost function generation method for a cost function generation device, the cost function generation method including: acquiring parameter information including N (an integer equal to or more than 1) as a parameter; and generating, based on the parameter information, a cost function including a plurality of binary variables for calculating a unit commitment schedule for a plurality of power generating units over a plurality of consecutive time frames by quadratic unconstrained binary optimization, wherein the cost function includes the amount of power generation in each of the time frames and each of the power generating units, the plurality of binary variables include N first binary variables in each of the time frames and each of the power generating units, and the amount of power generation is expressed using any one of 2^{N} patterns with the N first binary variables.

Thus, the amount of power generation can be expressed with fewer binary variables by such a composition that 2^{N} amounts of power generation are expressed with N first binary variables.

A processing device according to yet another aspect of the present invention includes a quantum computer unit that optimizes the plurality of binary variables so that costs based on the cost function generated by the above cost function generation method are reduced.

Thus, the amount of power generation can be expressed with fewer binary variables by such a composition that 2^{N} amounts of power generation are expressed with N first binary variables. Then, a cost function with traditional costs and constraint conditions in the UCP represented therein is generated in a form suitable for optimization by the quantum computer unit, and a unit commitment schedule for power generating units, which meets the constraint conditions and reduces the costs, can be obtained efficiently by such a composition that the plurality of binary variables are optimized by the quantum computer unit.

A cost function generation program according to a further aspect of the present invention is a cost function generation program used in a cost function generation device, the cost function generation program causing a computer to function as: a parameter information acquisition unit that acquires parameter information including N (an integer equal to or more than 1) as a parameter; and a function generation unit that generates, based on the parameter information, a cost function including a plurality of binary variables for calculating a unit commitment schedule for a plurality of power generating units over a plurality of consecutive time frames by quadratic unconstrained binary optimization, wherein the cost function includes the amount of power generation in each of the time frames and each of the power generating units, the plurality of binary variables include N first binary variables in each of the time frames and each of the power generating units, and the amount of power generation is expressed using any one of 2^{N} patterns with the N first binary variables.

Thus, the amount of power generation can be expressed with fewer binary variables by such a composition that 2^{N} amounts of power generation are expressed with N first binary variables.

According to the present disclosure, the cost function generation device, the processing device, the cost function generation method, and the cost function generation program capable of expressing the amount of power generation with fewer binary variables can be provided.

### BRIEF DESCRIPTION OF DRAWINGS

FIG. 1 is a diagram for describing a unit commitment schedule for power generating units according to one embodiment of the present disclosure.

FIG. 2 is a diagram illustrating the configuration of a processing device according to the embodiment of the present disclosure.

FIG. 3 is a flowchart that defines an operating procedure when the processing device performs cost calculation processing according to the embodiment of the present disclosure.

### DESCRIPTION OF EMBODIMENT

An embodiment of the present invention will be described with reference to the accompanying drawings. Note that those to which the same reference numerals are given in respective figures have the same or similar configuration/composition.

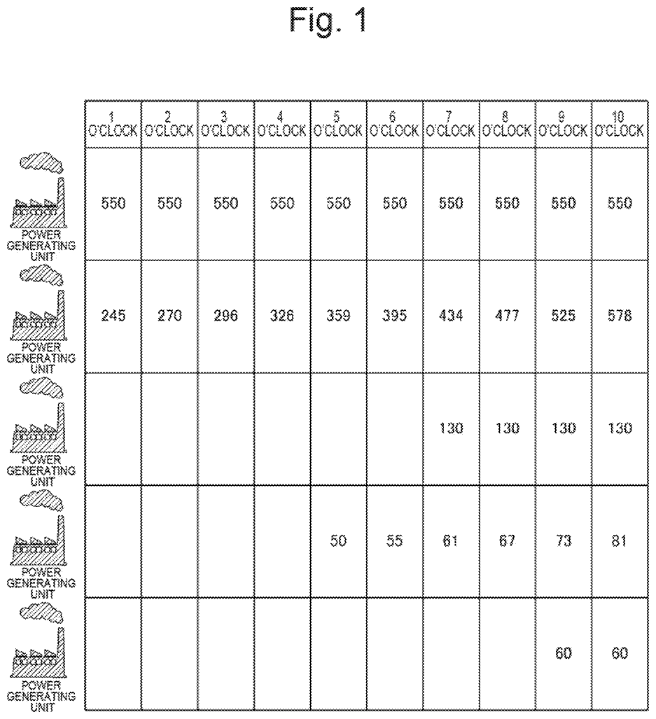

FIG. 1 is a diagram for describing a unit commitment schedule for power generating units according to one embodiment of the present disclosure. As illustrated in FIG. 1, the unit commitment schedule for power generating units is a schedule for power supplied respectively from plural power generating units over plural consecutive time frames, that is, a schedule for the amount of power generation in each time frame and each power generating unit.

In FIG. 1, for example, a schedule from 1 o'clock to 10 o'clock is illustrated. The unit of time frame and the number of time frames are one hour and ten, respectively. The number of power generating units is five. Note that the unit of time frame may be shorter or longer than one hour. The number of time frames may be not less than two and not more than nine, or eleven or more. The number of power generating units may be not less than two and not more than four, or six or more.

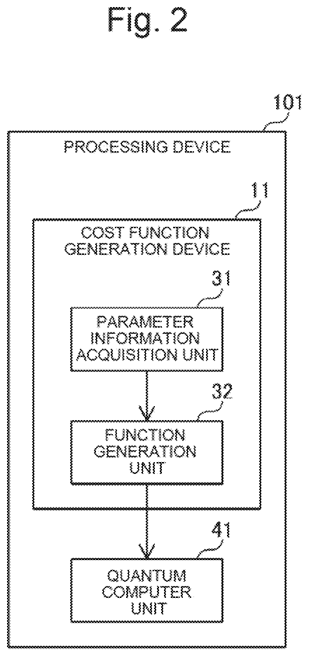

FIG. 2 is a diagram illustrating the configuration of a processing device according to one embodiment of the present disclosure. As illustrated in FIG. 2, a processing device 101 includes a cost function generation device 11 and a quantum computer unit 41. The cost function generation device 11 includes a parameter information acquisition unit 31 and a function generation unit 32.

The parameter information acquisition unit 31 acquires parameter information. The parameter information is generated, for example, by a manager who manages a unit commitment schedule for power generating units. For example, the parameter information includes N, F, H, U, Aᵢ, Bᵢ, Cᵢ, Lₜ, Rₜ, P_{max,i}, P_{min,i}, P_{up,i}, P_{down,i}, T_{min,on,i}, T_{min, off,i}, C_{start,i}, C_{shut,i}, T_{on,i}⁻¹, and T_{off,i}⁻¹ as parameters.

N and F are, for example, integers equal to or more than 1. H and U are the number of time frames and the number of power generating units, respectively, which are, for example, integers equal to or more than 1.

Aᵢ, Bᵢ, and Cᵢ are parameters for power generation cost calculation of a power generating unit with index i, which are real numbers equal to or more than zero.

Lₜ and Rₜ are a power demand and a spinning reserve in a time frame with index t, respectively, which are real numbers equal to or more than zero.

P_{max,i} and P_{min,i} are the maximum power generation and the minimum power generation of the power generating unit with index i, respectively, which are real numbers equal to or more than zero.

P_{up,i} and P_{down,i} are a power incremental limit value and a power decremental limit value of the power generating unit with index i, respectively, which are real numbers equal to or more than zero. T_{min,on,i} and T_{min,off,i} are a minimum uptime and a minimum downtime of the power generating unit with index i, respectively, which are integers equal to or more than zero.

C_{start,i} and C_{shut,i} are a startup cost and a shutdown cost in the power generating unit with index i, respectively, which are real numbers equal to or more than zero.

T_{on,i}⁻¹ and T_{off,i}⁻¹ are a continuous uptime period and a continuous downtime period of the power generating unit with index i in time frames with an index being zero, respectively, which are integers equal to or more than zero.

As traditional variables in the UCP, there are pᵢ^{t}, T_{on,i}^{t}, and dᵢ^{t}. pᵢ^{t} is the amount of power generation of the power generating unit with index i in the time frame with index t, which is a real number equal to or more than zero. T_{on,i}^{t} is a continuous uptime period of the power generating unit with index i in the time frame with index t, which is an integer equal to or more than zero. dᵢ^{t} indicates either an ON state or an OFF state of the power generating unit with index i in the time frame with index t, which has a value of zero or 1.

In the present embodiment, when the power generating unit concerned is ON or OFF, dᵢ^{t} has 1 or zero, respectively.

A traditional generation cost in the UCP is given, for example, by Σₜ₌₀^{H-1}Σᵢ₌₀^{U-1} {Aᵢ·dᵢ^{t}+Bᵢ·pᵢ^{t}+Cᵢ·(pᵢ^{t})²}.

A traditional startup cost in the UCP is given, for example, by Σₜ₌₀^{H-1}Σᵢ₌₀^{U-1}C_{start,i}·dᵢ^{t}·(1−dᵢ^{t-1}).

A traditional shutdown cost in the UCP is given, for example, by Σₜ₌₀^{H-1}Σᵢ₌₀^{U-1} C_{shut,i}·(1−dᵢ^{t})·dᵢ^{t-1}.

Respective traditional constraint conditions in the UCP are, for example, upper and lower limit constraints on the output of each power generating unit, a supply-demand balance constraint, a spinning reserve constraint, a power increase constraint, a power decrease constraint, a minimum uptime constraint on each power generating unit, an uptime equation, a minimum downtime constraint on each power generating unit, and a downtime equation.

The upper and lower limit constraints on the output of the power generating unit are given, for example, by P_{min,i}·dᵢ^{t}≤pᵢ^{t}≤P_{max,i}·dᵢ^{t}.

The supply-demand balance constraint is given, for example, by Σᵢ₌₀^{U-1}·pᵢ^{t}=Lₜ. The spinning reserve constraint is given, for example, by Σᵢ₌₀^{U-1}P_{max,i}·dᵢ^{t}≥Lₜ+Rₜ.

The power increase constraint is given, for example, by pᵢ^{t}-pᵢ^{t-1}≤P_{up,i}. The power decrease constraint is given, for example, by −P_{down,i}≤pᵢ^{t}−pᵢ^{t-1}.

The minimum uptime constraint on the power generating unit is given by (dᵢ^{t-1}−dᵢ^{t})(T_{on,i}^{t-1}−T_{min,on,i})≥0. The uptime equation is given, for example, by T_{on,i}^{t}=T_{on,i}^{t-1}·dᵢ^{t}+dᵢ^{t}.

The minimum downtime constraint on the power generating unit is given by (dᵢ^{t}-dᵢ^{t-1}) (T_{off,i}^{t-1}-T_{min,off,i})≥0. The downtime equation is given, for example, by T_{off,i}^{t}=T_{off,i}^{t-1}·(1-dᵢ^{t})+ (1-dᵢ^{t}).

The function generation unit 32 generates a cost function Cqubo including plural binary variables based on parameter information. The cost function Cqubo is a function for calculating a unit commitment schedule for plural power generating units over plural consecutive time frames by quadratic unconstrained binary optimization. The cost function Cqubo is expressed, for example, in Equation (12).

$$\begin{matrix}[ Math . 12 ] & \\ {C}_{qubo} = {Q}_{0} + {\sum }_{i = 1}^{10} {π}_{i} {Q}_{i} & ( 12 )\end{matrix}$$

Here, i is an index. Q₀ and Qᵢ are variables. In detail, the variable Q₀ is a cost term that expresses traditional generation cost, startup cost, and shutdown cost in the UCP by binary variables.

The variable Qᵢ is a constraint term that expresses each of traditional constraint conditions in the UCP by binary variables. πᵢ is a large positive number to give a penalty.

Specifically, a variable Q₁ is a constraint term that expresses traditional upper and lower limit constraints on the output of the power generating unit in the UCP by binary variables.

A variable Q₂ is a constraint term that expresses a traditional supply-demand balance constraint in the UCP by binary variables. Q₃ is a constraint term that expresses a traditional spinning reserve constraint in the UCP by binary variables.

Variables Q₄ and Q₅ are constraint terms that express traditional power increase constraint and power decrease constraint in the UCP by binary variables, respectively.

A variable Q₆ is a constraint term that expresses traditional minimum uptime constraint and uptime equation in the UCP by a sixth binary variable aᵢ^{t,t2} and a seventh binary variable η_{i,j}^{t}. A variable Q₇ is a constraint term to ensure that the sixth binary variable aᵢ^{t,t2} used for the variable Q₆ is valid.

A variable Q₈ is a constraint term that expresses traditional minimum downtime constraint and downtime equation in the UCP by an eighth binary variable bᵢ^{t,t2} and a ninth binary variable γ_{i,j}^{t}. A variable Q₉ is a constraint term to ensure that the eighth binary variable bᵢ^{t,t2} used for the variable Q₈ is valid.

A variable Q₁₀ is a constraint term to ensure that a second binary variable aᵢ^{t,t} used for the variable Q₆ and a tenth binary variable bᵢ^{t,t} used for the variable Q₈ are complementary logic variables.

### (Variable Q₀)

The cost function Cqubo includes the amount of power generation, pᵢ^{t}, in each time frame and each power generating unit. Specifically, the variable Q₀ is expressed in Equation (13).

$$\begin{matrix}[ Math . 13 ] & \\ {Q}_{0} = {\sum }_{t = 0}^{H - 1} {\sum }_{i = 0}^{U - 1} ( {A}_{i} {a}_{i}^{t , t} + {B}_{i} [ ( {P}_{max , i} - {P}_{min , i} ) ( {\sum }_{k = 1}^{N} {2}^{- k} {z}_{ik}^{t} ) + {P}_{min , i} {a}_{i}^{t , t} ] + {{C}_{i} [ ( {P}_{max , i} - {P}_{min , i} ) ( {\sum }_{k = 1}^{N} {2}^{- k} {z}_{ik}^{t} ) + {P}_{min , i} {a}_{i}^{t , t} ]}^{2} + {C}_{start , i} {a}_{i}^{t , t} ( 1 - {a}_{i}^{t - 1 , t - 1} ) + {C}_{shut , i} ( 1 - {a}_{i}^{t , t} ) {a}_{i}^{t - 1 , t - 1} \} & ( 13 )\end{matrix}$$

Here, t and i are indexes of the time frame and the power generating unit, respectively. A range of index t is t∈[0, H−1]. A range of index i is i∈[0, U−1].

The amount of power generation, pit, of the power generating unit i in the time frame t is expressed in Formula (8). Here, zᵢₖ^{t} is a first binary variable. The binary variable indicates either zero or 1. k is an index. A range of index k is k∈[1, N]. The precision of power generation amount of the power generating unit i is determined by N.

aᵢ^{t,t} is a second binary variable indicative of either an ON state or an OFF state of the power generating unit with index i (which may also be called the power generating unit i below) in the time frame with index t (which may also be called the time frame t below). A relationship between aᵢ^{t,t} and the traditional variable in the UCP is aᵢ^{t,t}=dᵢ^{t}. In other words, when the power generating unit i is ON or OFF in the time frame t, aᵢ^{t,t} has 1 or zero, respectively.

The amount of power generation, pit, is expressed using any one of 2^{N} patterns. In detail, Σₖ₌₁^{N}2^{-k}zᵢₖ^{t} represents a positive decimal number with a precision of ½^{N}. The amount of power generation, pᵢ^{t}, is expressed at an interval obtained by multiplying (P_{max,i}−P_{min,i}) by the decimal number concerned.

The startup cost when the power generating unit i starts operating is expressed by C_{start,i}·aᵢ^{t,t}·(1−aᵢ^{t-1,t-1}). C_{start,i}·aᵢ^{t,t}·(1−aᵢ^{t-1,t-1}) gives C_{start,i} when the power generating unit i is in the OFF state in the time frame t−1 and the power generating unit i is in the ON state in the time frame t immediately after the time frame t−1.

The shutdown cost when the power generating unit i stops operating is expressed by C_{shut,i}·(1−aᵢ^{t,t})·aᵢ^{t-1,t-1}. C_{shut,i}·(1−aᵢ^{t,t})·aᵢ^{t-1,t-1} gives C_{shut,i} when the power generating unit i is in the ON state in the time frame t−1 and the power generating unit i is in the OFF state in the time frame t immediately after the time frame t−1.

### (Variable Q₁)

The cost function Cqubo includes the variable Q₁ (an example of a “first constraint term”) that indicates the sum of N first binary variables zᵢₖ^{t} of a first power generating unit in a first time frame when the second binary variable aᵢ^{t,t} of the first power generating unit indicates OFF in the first time frame.

Specifically, the variable Q₁ is expressed in Equation (1). When the second binary variable aᵢ^{t,t} of the first power generating unit indicates ON in the first time frame, since (1−aᵢ^{t,t}) is zero, Σₖ₌₁^{N}zᵢₖ^{t} is not reflected in the cost function Cqubo regardless of the value.

On the other hand, when the second binary variable aᵢ^{t,t} indicates OFF, since (1−aᵢ^{t,t}) is 1, Σₖ₌₁^{N}zᵢₖ^{t} is reflected in the cost function Cqubo. Therefore, in the process of optimization, Σₖ₌₁^{N}zᵢₖ^{t} is optimized to be close to zero. For example, when Σₖ₌₁^{N}zᵢₖ^{t} is zero, since Σₖ₌₁^{N}2^{-k}zᵢₖ^{t} is zero, the amount of power generation, pᵢ^{t}, of the power generating unit i in the time frame t is zero from Formula (8).

### (Variable Q₂)

The cost function Cqubo includes the variable Q₂ (an example of a “second constraint term”) having a value according to the magnitude of a difference between the sum of amounts of power generation, pᵢ^{t}, of plural power generating units in a second time frame and a power demand Lₜ in the second time frame.

Specifically, the variable Q₂ is expressed in Equation (2). In the present embodiment, the square of the difference between the sum of amounts of power generation, pᵢ^{t}, of the plural power generating units in the second time frame and the power demand Lₜ in the second time frame is reflected in the variable Q₂.

In the process of optimization, the first binary variable zᵢₖ^{t} and the second binary variable aᵢ^{t,t} are so optimized in each time frame that the sum of amounts of power generation, pᵢ^{t}, of the plural power generating units and the power demand Lₜ are approached to be balanced out.

### (Variable Q₃)

Plural binary variables include plural third binary variables ψₖ^{t} for representing positive real terms in each time frame. In detail, the plural third binary variables ψₖ^{t} are F third binary variables ψₖ^{t} in each time frame to represent a first decimal number equal to or more than zero using any one of 2^{F} patterns. The first decimal number equal to or more than zero is, for example, Σₖ₌₁^{F}2^{-k}ψₖ^{t}, which represents a positive decimal number with a precision of ½^{F}.

The cost function Cqubo includes the variable Q₃ (an example of a “third constraint term”) having a value according to the magnitude of a difference between a value obtained by subtracting a second sum from a first sum, and a real term. Specifically, the variable Q3 is expressed in Equation (3).

Here, the first sum is the sum of amounts of maximum power generation P_{max,i} of power generating units for which the second binary variable aᵢ^{t,t} indicates ON state in a third time frame, that is, Σᵢ₌₀^{U-1}P_{max,i}aᵢ^{t,t}. The second sum is the sum of the power demand Lₜ and the spinning reserve Rₜ in the third time frame. The real term is a value obtained by multiplying, by a first decimal number equal to or more than zero in the third time frame, a value obtained by subtracting the second sum from a third sum. The third sum is the sum of amounts of maximum power generation, P_{max,i}, Of the plural power generating units, that is, Σᵢ₌₀^{U-1}P_{max,i}.

In the present embodiment, the square of a difference between the value obtained by subtracting the second sum from the first sum in the third time frame, and the value obtained by multiplying, by the first decimal number equal to or more than zero, the value obtained by subtracting the second sum from the third sum is reflected in the variable Q₃.

Since the first sum, that is, Σᵢ₌₀^{U-1}P_{max,i}aᵢ^{t,t} is equal to or less than the third sum, that is, Eᵢ₌₀^{U-1}P_{max,i}, when the first sum is equal to or more than the second sum in each time frame, F third binary variables ψₖ^{t} with the difference mentioned above being close to zero exist. Therefore, in the process of optimization, the second binary variable aᵢ^{t,t} and the third binary variable ψₖ^{t} are so optimized that the difference mentioned above is close to zero in each time frame.

### (Variable Q₄)

The plural binary variables include plural fourth binary variables χ_{i,k}^{t} for representing a second decimal number equal to or more than zero in each time frame and each power generating unit. In detail, the plural fourth binary variables χ_{i,k}^{t} are F fourth binary variables χ_{i,k}^{t} in each time frame and each power generating unit to represent the second decimal number equal to or more than zero using any one of 2^{F} patterns. The second decimal number equal to or more than zero is, for example, Σₖ₌₁^{F}2^{-k}χ_{i,k}^{t} to represent a decimal number equal to or more than zero with a precision of ½^{F}.

The cost function Cqubo includes the variable Q₄ (an example of a “fourth constraint term”) having a value according to the sum of a value obtained by subtracting a power incremental limit value P_{up,i} from a fourth sum, and a product of a second decimal number equal to or more than zero of a second power generating unit in a fourth time frame and a positive predetermined value. Specifically, the variable Q₄ is expressed in Equation (4).

Here, the fourth sum is a value obtained by subtracting the amount of power generation of the second power generating unit in a time frame immediately before the fourth time frame from the amount of power generation of the second power generating unit in the fourth time frame, that is, (P_{max,i}−P_{min,i}) {Σₖ₌₁^{N}2^{-K} (zᵢₖ^{t}−zᵢₖ^{t-1})}+P_{min,i} (aᵢ^{t,t}−aᵢ^{t-1,t-1}). In other words, the fourth sum is an increase in the power generation of the second power generating unit over a period from the time frame immediately before the fourth time frame to the fourth time frame. The positive predetermined value is, for example, the sum of the power incremental limit value P_{up,i} and the power decremental limit value P_{down,i}, that is, P_{up,i}+P_{down,i}.

In the present embodiment, the square of the sum of a value obtained by subtracting the power incremental limit value P_{up,i} from the fourth sum in the fourth time frame, and a value obtained by multiplying the sum of the power incremental limit value P_{up,i} and the power decremental limit value P_{down,i} by the second decimal number equal to or more than zero of the second power generating unit in the fourth time frame is reflected in the variable Q₄.

It is preferable that the value obtained by subtracting the power incremental limit value P_{up,i} from the increase in the power generation of the second power generating unit over the period from the time frame immediately before the fourth time frame to the fourth time frame is zero or less. (P_{up,i}+P_{down,i})·Σₖ₌₁^{F}2^{-k}χ_{i,k}^{t} is a positive real number not less than zero and not more than (P_{up,i}+P_{down,i}). Therefore, in the process of optimization, the first binary variable zᵢₖ^{t}, the second binary variable aᵢ^{t,t}, and the fourth binary variable χ_{i,k}^{t} are so optimized in each time frame and each power generating unit that the value obtained by subtracting the power incremental limit value P_{up,i} from the increase in the power generation of the second power generating unit over the period from the time frame immediately before the fourth time frame to the fourth time frame is equal to or less than zero.

### (Variable Q₅)

The plural binary variables include plural fifth binary variables φ_{i,k}^{t} for representing a third decimal number equal to or more than zero in each time frame and each power generating unit. In detail, the plural fifth binary variables φ_{i,k}^{t} are F fifth binary variables φ_{i,k}^{t} in each time frame and each power generating unit to represent the third decimal number equal to or more than zero using any one of 2^{F} patterns. The third decimal number equal to or more than zero is, for example, Σₖ₌₁^{F}2^{-k}φ_{i,k}^{t} to represent a decimal number equal to or more than zero with a precision of ½^{F}.

The cost function Cqubo includes the variable Q₅ (an example of a “fifth constraint term”) having a value according to the magnitude of a difference between a value obtained by adding the power decremental limit value P_{down,i} to the fourth sum, and a product of the third decimal number equal to or more than zero of the second power generating unit in the fourth time frame and a positive predetermined value. Specifically, the variable Q₅ is expressed in Equation (5). Here, the positive predetermined value is, for example, the sum of the power incremental limit value P_{up,i} and power decremental limit value P_{down,i}, that is, P_{up,i}+P_{down,i}.

In the present embodiment, the square of a difference between a value obtained by adding the power decremental limit value P_{down,i} to the fourth sum in the fourth time frame, and a value obtained by multiplying the sum of the power incremental limit value P_{up,i} and the power decremental limit value P_{down,i} by the third decimal number equal to or more than zero of the second power generating unit in the fourth time frame is reflected in the variable Q₅.

It is preferable that a value obtained by adding the power decremental limit value P_{down,i} to the increase in the power generation of the second power generating unit over a period from the time frame immediately before the fourth time frame to the fourth time frame is zero or more. (P_{up,i}+P_{down,i})·Σₖ₌₁^{F}2^{-k}φ_{i,k}^{t} is a positive real number not less than zero and not more than (P_{up,i}+P_{down,i}). Therefore, in the process of optimization, the first binary variable zᵢₖ^{t}, the second binary variable aᵢ^{t,t}, and the fifth binary variable φ_{i,k}^{t} are so optimized in each time frame and each power generating unit that the value obtained by adding the power decremental limit value P_{down,i} to the increase in the power generation of the second power generating unit over the period from the time frame immediately before the fourth time frame to the fourth time frame is zero or more.

### (Variable Q₆)

The plural binary variables include plural sixth binary variables aᵢ^{t1,t2} in each end time frame and each start time frame before the end time frame, and in each power generating unit. Here, t2≤t1. The number of sixth binary variables aᵢ^{t1,t2} is U·H(H+1)/2. The second binary variable aᵢ^{t1,t1} is the sixth binary variable aᵢ^{t1,t2} in the case of t2=t1.

The sixth binary variable aᵢ^{t1,t2} indicates a product of ON states or OFF states of the power generating unit in respective time frames after the start time frame and before the end time frame. Specifically, when the indexes of the time frames meet 0≤t2≤t1<H, the sixth binary variable aᵢ^{t1,t2} is defined by Formula (14).

$$\begin{matrix}[ Math . 14 ] & \\ {a}_{i}^{{t}_{1} , {t}_{2}} = {d}_{i}^{{t}_{1}} {d}_{i}^{{t}_{1} - 1} … {d}_{i}^{{t}_{2}} & ( 14 )\end{matrix}$$

The plural binary variables further include plural seventh binary variables η_{i,j}^{t} for representing a first integer equal to or more than zero in each time frame with index t and each power generating unit. In detail, the plural seventh binary variables η_{i,j}^{t} are G seventh binary variables η_{i,j}^{t} in each time frame and each power generating unit to represent the first integer equal to or more than zero using any one of 2^{G} patterns. The first integer is, for example, Σⱼ₌₀^{G-1}2^{j}η_{i,j}^{t} to represent an integer equal to or more than zero with a precision of 2^{G}.

The cost function Cqubo includes the variable Q₆ (an example of a “sixth constraint term”) having a value according to the magnitude of a difference between an uptime constraint evaluation formula of a third power generating unit in a fifth time frame, and a first integer equal to or more than zero of the third power generating unit in the fifth time frame. Specifically, the variable Q₆ is expressed in Equation (6).

Here, a minimum uptime constraint evaluation formula of the power generating unit i when the index t is zero can be expressed by sixth binary variables aⱼ^{t1,t2} like in Formula (15).

$$\begin{matrix}[ Math . 15 ] & \\ ( {a}_{i}^{- 1 , - 1} - {a}_{i}^{0 , 0} ) ( {T}_{on , i}^{- 1} - {T}_{min , on , i} ) & ( 15 )\end{matrix}$$

Here, a variable with a negative index t (for example, aᵢ^{-1, -1}) is specified by an initial problem condition. The formula (15) expresses the minimum uptime constraint on a traditional power generating unit in the UCP, that is, the left side of (dᵢ^{t-1}−dᵢ^{t})(T_{on,i}^{t-1}−T_{min,on,i})≥0, by the formula including the sixth binary variables aᵢ^{t1,t2}.

In the present embodiment, the square of a difference between the minimum uptime constraint evaluation formula (15) as an integer, and the first integer when the index t is zero, that is, Σⱼ₌₀^{G-1}2^{j}η_{i,j}⁰, is reflected in the variable Q₆. When the value given by the minimum uptime constraint evaluation formula (15) is zero or more, that is, when the minimum uptime constraint on the power generating unit i for which the index t is zero is met, G seventh binary variables η_{i,0}⁰~η_{i,G-1}⁰ with the difference being zero exist. Therefore, in the process of optimization, the sixth binary variable aᵢ^{0,0} and the G seventh binary variables η_{i,0}⁰~n_{i,G-1}⁰ in a time frame with index t being zero and in each power generating unit are so optimized that the difference becomes zero.

T_{on,i}^{t}=T_{on,i}^{t-1}·dᵢ^{t}+dᵢ^{t} as the uptime equation described above can be expressed by sixth binary variables aᵢ^{t,t2} and T_{on,i}⁻¹ like in Equation (16).

$$\begin{matrix}[ Math . 16 ] & \\ {T}_{on , i}^{t} = {\sum }_{{t}_{2} = 0}^{t} {a}_{i}^{t , {t}_{2}} + {a}_{i}^{t , 0} {T}_{on , i}^{- 1} & ( 16 )\end{matrix}$$

A minimum uptime constraint evaluation formula on the power generating unit i when the index t is 1 or more can be expressed by the sixth binary variables aᵢ^{t1,t2} and Equation (16) like in Formula (17).

$$\begin{matrix}[ Math . 17 ] & \\ [ {\sum }_{{t}_{2} = 0}^{t - 1} ( {b}_{i}^{t - 1 , {t}_{2}} - {b}_{i}^{t , {t}_{2}} ) ] + ( {a}_{i}^{t - 1 , 0} - {a}_{i}^{t , 0} ) {T}_{on , i}^{- 1} - ( {a}_{i}^{t - 1 , t - 1} - {a}_{i}^{t , t} ) {T}_{min , on , i} & ( 17 )\end{matrix}$$

The formula (17) expresses the minimum uptime constraint on a traditional power generating unit in the UCP, that is, the left side of (dᵢ^{t-1}−dᵢ^{t}) (T_{on,i}^{t-1}−T_{min,on,i})≥0, by the sixth binary variables aᵢ^{t1,t2} and Equation (16).

The square of a difference between the minimum uptime constraint evaluation formula (17) as an integer, and a first integer when the index t is 1 or more, that is, Σⱼ₌₀^{G-1}2^{j}η_{i,j}^{t}, is further reflected in the variable Q₆. When the value given by the minimum uptime constraint evaluation formula (17) is zero or more, that is, when the minimum uptime constraint on the power generating unit i for which the index t is 1 or more is met, G seventh binary variables η_{i,0}^{t}~η_{i,G-1}^{t} with the difference being zero exist. Therefore, in the process of optimization, the sixth binary variables aᵢ^{t,t2} and the G seventh binary variables η_{i,0}^{t}~η_{i,G-1}^{t} are so optimized in a time frame with index t being 1 or more and in each power generating unit that the difference becomes zero.

In other words, the variable Q₆ expresses the minimum uptime constraint on a traditional power generating unit in the UCP, that is, (dᵢ^{t-1}−dᵢ^{t})(T_{on,i}^{t-1}−T_{min,on,i})≥0, by an equation including the sixth binary variables aᵢ^{t1,t2} and the seventh binary variables η_{i,j}^{t}.

### (Variable Q₇)

The cost function Cqubo includes the variable Q₇ (an example of a “seventh constraint term”) having a Rosenberg's formula for evaluating that the plural sixth binary variables aᵢ^{t1,t2} are valid (Non-Patent Literature 2). Specifically, the variable Q₇ is expressed in Equation (7). Here, the Rosenberg's formula is expressed in Formula (18).

$$\begin{matrix}[ Math . 18 ] & \\ {x}_{1} \cdot {x}_{2} - 2 ( {x}_{1} + {x}_{2} ) y + 3 y & ( 18 )\end{matrix}$$

In the case of y, x₁, x₂∈{0,1}, the Rosenberg's formula (18) gives values of 8 patterns illustrated in Table 1. In the case of a set of y, x₁, and x₂ that the equation y=x₁·x₂ holds true, the Rosenberg's formula (18) gives zero. On the other hand, in the case of a set of y, x₁, and x₂ that the equation y=x₁·x₂ does not hold true, the Rosenberg's formula (18) gives 1 or 3. In other words, the Rosenberg's formula (18) is a quadratic penalty cost function to give a penalty when the equation y=x₁·x₂ does not hold true in the case of y, x₁, x₂∈{0, 1}.

TABLE 1

| y | x₁ | x₂ | x₁x₂ − 2(x₁+ x₂)y + 3y | y = x₁x₂ |
|---|---|---|---|---|
| 0 | 0 | 0 | 0 | True |
| 0 | 0 | 1 | 0 | True |
| 0 | 1 | 0 | 0 | True |
| 0 | 1 | 1 | 1 | Not True |
| 1 | 0 | 0 | 3 | Not True |
| 1 | 0 | 1 | 1 | Not True |
| 1 | 1 | 0 | 1 | Not True |
| 1 | 1 | 1 | 0 | True |

The sixth binary variable aᵢ^{t1,t2} can be expressed by a product of two sixth binary variables aᵢ^{t1,t1} and aᵢ^{t1-1,t2} as illustrated in Equation (19). It is required that Equation (19) should hold true in any indexes t1 and t2.

$$\begin{matrix}[ Math . 19 ] & \\ {a}_{i}^{{t}_{1} , {t}_{2}} = {a}_{i}^{{t}_{1} , {t}_{1}} {a}_{i}^{{t}_{1} - 1 , {t}_{2}} & ( 19 )\end{matrix}$$

The variable Q₇ in Equation (7) is derived by applying Equation (19) to the Rosenberg's formula (18) and summing up the indexes t1, t2, and i. Here, 0≤t2<t1<H and 0≤i<U.

### (Variable Q₈)

The plural binary variables include plural eighth binary variables bᵢ^{t1,t2} in each end time frame, in each start time frame before the end time frame, and in each power generating unit. Here, t2≤t1. There are U·H (H+1)/2 eighth binary variables bᵢ^{t1,t2}.

A binary variable bᵢ^{t1,t1} is an eighth binary variable bᵢ^{t1,t2} when t2=t1 (hereinafter, which may also be called a tenth binary variable bᵢ^{t1,t1}). bᵢ^{t1,t1} indicates either the OFF state or the ON state of the power generating unit i in the time frame t1. The relationship of bᵢ^{t1,t1} with a traditional variable in the UCP is bᵢ^{t1,t1}=(1−dᵢ^{t1}). In other words, bᵢ^{t1,t1} is an inverted version of aᵢ^{t1,t1}. Specifically, when the power generating unit i is ON or OFF in the time frame t1, bᵢ^{t1,t1} has zero or 1, respectively.

The eighth binary variable bᵢ^{t1,t2} indicates a product of the ON states or the OFF states of the power generating units in each time frame after the start time frame and before the end time frame. Specifically, when the index of each time frame meets 0≤t2≤t1<H, the eighth binary variable bᵢ^{t1,t2} is defined by Congruence Equation (20).

$$\begin{matrix}[ Math . 20 ] & \\ {b}_{i}^{{t}_{1} , {t}_{2}} ≡ ( 1 - {d}_{i}^{{t}_{1}} ) ( 1 - {d}_{i}^{{t}_{1} - 1} ) … ( 1 - {d}_{i}^{{t}_{2}} ) & ( 20 )\end{matrix}$$

The plural binary variables further include plural ninth binary variables γ_{i,j}^{t} for representing a second integer equal to or more than zero in each time frame with index t and each power generating unit. In detail, the plural ninth binary variables γ_{i,j}^{t} are G ninth binary variables γ_{i,j}^{t} in each time frame and each power generating unit to represent the second integer equal to or more than zero using any one of 2^{G} patterns. The second integer is, for example, Σⱼ₌₀^{G-1}2^{j}γ_{i,j}^{t} to represent an integer equal to or more than zero with a precision of 2^{G}.

The cost function Cqubo includes the variable Q₈ (an example of an “eighth constraint term”) having a value according to the magnitude of a difference between a downtime constraint evaluation formula of a fourth power generating unit in a sixth time frame, and a second integer equal to or more than zero for the fourth power generating unit in the sixth time frame. Specifically, the variable Q₈ is expressed in Equation (9).

4 Here, a minimum downtime constraint evaluation formula for the power generating unit i when the index t is zero can be expressed by eighth binary variables bᵢ^{t1,t2} like in Formula (21).

$$\begin{matrix}[ Math . 21 ] & \\ ( {b}_{i}^{- 1 , - 1} - {b}_{i}^{0 , 0} ) ( {T}_{off , i}^{- 1} - {T}_{min , off , i} ) & ( 21 )\end{matrix}$$

Formula (21) expresses the minimum downtime constraint on a traditional power generating unit in the UCP, that is, the left side of (dᵢ^{t}−dᵢ^{t-1}) (T_{off,i}^{t-1}-T_{min,off,i})≥0 by the formula including the eighth binary variables bᵢ^{t1,t2}.

In the present embodiment, the square of a difference between the minimum downtime constraint evaluation formula (21) as an integer and the second integer when the index t is zero, that is, Σⱼ₌₀^{G-1}2^{j}γ_{i,j}⁰, is reflected in the variable Q₈. When the value given by the minimum downtime constraint (21) is zero or more, that is, when the minimum downtime constraint on the power generating unit i for which the index t is zero is met, G ninth binary variables γ_{i,0}⁰~γ_{i,G-1}⁰ for which the difference is zero exist. Therefore, in the process of optimization, the eighth binary variable bᵢ^{0,0} and the G ninth binary variables γ_{i,0}⁰~γ_{i,G-1}⁰ in a time frame with index t being zero and in each power generating unit are so optimized that the difference becomes zero.

T_{off,i}^{t}=T_{off,i}^{t-1}·(1−dᵢ^{t})+ (1−dᵢ^{t}) as the downtime equation described above can be expressed by the eighth binary variables bᵢ^{t,t2} and T_{off,i}⁻¹ like in Equation (22).

$$\begin{matrix}[ Math . 22 ] & \\ {T}_{off , i}^{t} = {\sum }_{{t}_{2} = 0}^{t} {b}_{i}^{t , {t}_{2}} + {b}_{i}^{t , 0} {T}_{off , i}^{- 1} & ( 22 )\end{matrix}$$

A minimum downtime constraint evaluation formula for the power generating unit i when the index t is 1 or more can be expressed by eighth binary variables bᵢ^{t1,t2} and Equation (22) like in Formula (23).

$$\begin{matrix}[ Math . 23 ] & \\ [ {\sum }_{{t}_{2} = 0}^{t - 1} ( {b}_{i}^{t - 1 , {t}_{2}} - {b}_{i}^{t , {t}_{2}} ) ] + ( {b}_{i}^{t - 1 , 0} - {b}_{i}^{t , 0} ) {T}_{off , i}^{- 1} - ( {b}_{i}^{t - 1 , t - 1} - {b}_{i}^{t , t} ) {T}_{min , off , i} & ( 23 )\end{matrix}$$

Formula (23) expresses the minimum downtime constraint on a traditional power generating unit in the UCP, that is, the left side of (dᵢ^{t}−dᵢ^{t-1})(T_{off,i}^{t-1}−T_{min,off,i})≥0 by the eighth binary variables bᵢ^{t,t2} and Equation (22).

The square of a difference between the minimum downtime constraint evaluation formula (23) as an integer and the second integer when the index t is 1 or more, that is, Σⱼ₌₀^{G-1}2^{j}γ_{i,j}^{t}, is further reflected in the variable Q₈. When the value given by the minimum downtime constraint evaluation formula (23) is zero or more, that is, when the minimum downtime constraint on the power generating unit i for which the index t is 1 or more is met, G ninth binary variables γ_{i,0}^{t}~γ_{i,G-1}^{t} for which the difference is zero exist. Therefore, in the process of optimization, the eighth binary variables bᵢ^{t,t2} and the G ninth binary variables γ_{i,0}^{t}~γ_{i,G-1}^{t} in a time frame with index t being 1 or more and in each power generating unit are so optimized that the difference becomes zero.

In other words, the variable Q₈ expresses the minimum downtime constraint on a traditional power generating unit in the UCP, that is, (dᵢ^{t}−dᵢ^{t-1})(T_{off,i}^{t-1}-T_{min,off,i})≥0 by the formula including the eighth binary variables bᵢ^{t1,t2} and the ninth binary variables γ_{i,j}^{t}.

### (Variable Q₉)

The cost function Cqubo includes the variable Q₉ (an example of a “ninth constraint term”) having the Rosenberg's formula (18) for evaluating that the plural eighth binary variables bᵢ^{t1,t2} are valid. Specifically, the variable Q₉ is expressed in Equation (10).

The eighth binary variable bᵢ^{t1,t2} can be expressed by a product of two eighth binary variables bᵢ^{t1,t1} and bᵢ^{t1-1,t2} as illustrated in Equation (24). It is required that Equation (24) should hold true in any indexes t1 and t2.

$$\begin{matrix}[ Math . 24 ] & \\ {b}_{i}^{{t}_{1} , {t}_{2}} = {b}_{i}^{{t}_{1} , {t}_{1}} {b}_{i}^{{t}_{1} - 1 , {t}_{2}} & ( 24 )\end{matrix}$$

The variable Q₉ in Equation (10) is derived by applying Equation (24) to the Rosenberg's formula and summing up the indexes t1, t2, and i. Here, 0≤t2<t1<H and 0≤i<U.

### (Variable Q₁₀)

The cost function Cqubo includes the variable Q₁₀ (an example of a “tenth constraint term”) having a value obtained by subtracting 1 from the sum of the second binary variable aᵢ^{t,t} of the power generating unit i in the time frame with index t, and a tenth binary variable bᵢ^{t,t} in the time frame with index t.

In the present embodiment, the square of the value obtained by subtracting 1 from the sum of the second binary variable aᵢ^{t,t} of the power generating unit i in the time frame with index t and the tenth binary variable bᵢ^{t,t} of the power generating unit i in the time frame with index t is reflected in the variable Q₁₀. Specifically, the variable Q₁₀ is expressed in Equation (11).

When bᵢ^{t1,t1} is an inverted version of aᵢ^{t1,t1}, aᵢ^{t,t}+bᵢ^{t,t}−1 is zero. On the other hand, when bᵢ^{t1,t1} is not the inverted version of aᵢ^{t1,t1}, aᵢ^{t,t}+bᵢ^{t,t}−1 is 1 or −1. Therefore, in the process of optimization, the second binary variable aᵢ^{t,t} and the tenth binary variable bᵢ^{t,t} in each time frame and each power generating unit are so optimized that aᵢ^{t,t}+bᵢ^{t,t}−1 becomes zero. This can guarantee that the second binary variable aᵢ^{t,t} and the tenth binary variable bᵢ^{t,t} are complementary logic variables.

### [Cost Calculation Processing]

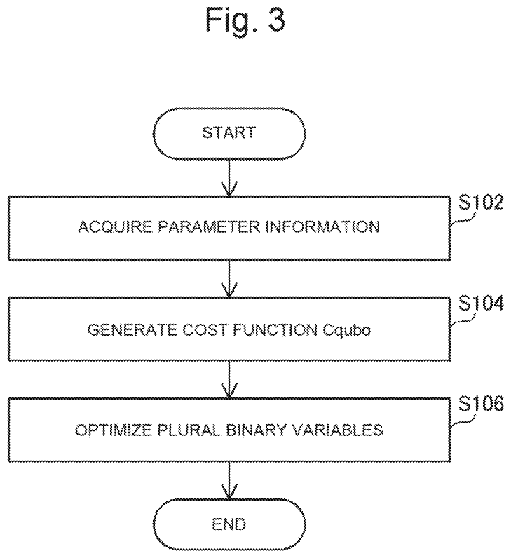

FIG. 3 is a flowchart that defines an operating procedure when the processing device performs cost calculation processing according to one embodiment of the present disclosure.

The processing device 101 includes a computer, and an arithmetic processing unit such as a CPU in the computer reads, from an unillustrated memory, and executes a program including some or all of respective steps of the flowchart to be described below. The program of the computer can be installed externally. The program of the computer is distributed in a state of being stored on a recording medium.

As illustrated in FIG. 3, the parameter information acquisition unit 31 in the processing device 101 first acquires parameter information (step S102).

Next, the function generation unit 32 generates the cost function Cqubo expressed in Equation (12) based on the parameter information (step S104).

Next, the quantum computer unit 41 optimizes plural binary variables to reduce costs based on the cost function Cqubo (step S106).

The embodiment described above is to facilitate the understanding of the present invention, which should not be interpreted as limiting the present invention. Elements provided in the embodiment, the arrangement, materials, conditions, shapes, and sizes of the elements, and the like are not limited to those exemplified, and they can be changed as appropriate. Further, configurations/compositions illustrated in different embodiments can be partially replaced or combined with each other.

### REFERENCE SIGNS LIST

11 . . . cost function generation device
31 . . . parameter information acquisition unit
32 . . . function generation unit
41 . . . quantum computer unit
101 . . . processing device

1. A cost function generation device comprising:
a parameter information acquisition unit that acquires parameter information including N (an integer equal to or more than 1) as a parameter; and
a function generation unit that generates, based on the parameter information, a cost function including a plurality of binary variables for calculating a unit commitment schedule for a plurality of power generating units over a plurality of consecutive time frames by quadratic unconstrained binary optimization, wherein
the cost function includes an amount of power generation in each of the time frames and each of the power generating units,
the plurality of binary variables include N first binary variables in each of the time frames and each of the power generating units, and
the amount of power generation is expressed using any one of 2^{N} patterns with the N first binary variables.

2. The cost function generation device according to claim 1, wherein
the parameter information includes H and U as parameters,
the plurality of binary variables include aᵢ^{t,t} as a second binary variable, and
the cost function includes following Equation (1) as a first constraint term:
$$\begin{matrix}[ Math . 1 ] & \\ {Q}_{1} = {\sum }_{t = 0}^{H - 1} {\sum }_{i = 0}^{U - 1} ( 1 - {a}_{i}^{t , t} ) ( {\sum }_{k = 1}^{N} {z}_{ik}^{t} ) & ( 1 )\end{matrix}$$
where H and U are the number of time frames and the number of power generating units, respectively,
t and i are indexes of one of the time frames and one of the power generating units, respectively,
aᵢ^{t,t} indicates either an ON state or an OFF state of the power generating unit with index i in the time frame with index t,
k is an index, and
zᵢₖ^{t} is the first binary variable.

3. The cost function generation device according to claim 1, wherein
the parameter information includes H, U, Lₜ, P_{max,i}, and P_{min,i} as parameters,
the plurality of binary variables include aᵢ^{t,t} as a second binary variable, and
the cost function includes following Equation (2) as a second constraint term:
$$\begin{matrix}[ Math . 2 ] & \\ {Q}_{2} = {\sum }_{t = 0}^{H - 1} {\{ {L}_{t} - {\sum }_{i = 0}^{U - 1} [ ( {P}_{max , i} - {P}_{min , i} ) ( {\sum }_{k = 1}^{N} {2}^{- k} {z}_{i k}^{t} ) + {P}_{min , i} {a}_{i}^{t , t} ] \}}^{2} & ( 2 )\end{matrix}$$
where H and U are the number of time frames and the number of power generating units, respectively,
t and i are indexes of one of the time frames and one of the power generating units, respectively,
aᵢ^{t,t} indicates either an ON state or an OFF state of the power generating unit with index i in the time frame with index t,
k is an index,
zᵢₖ^{t} is the first binary variable,
Lₜ is a power demand in the time frame with index t, and
P_{max,i} and P_{min,i} are maximum power generation and minimum power generation of the power generating unit with index i, respectively.

4. The cost function generation device according to claim 1, wherein
the parameter information includes H, U, Lₜ, P_{max,i}, Rₜ, and F as parameters,
the plurality of binary variables include aᵢ^{t,t} and ψₖ^{t} as a second binary variable and a third binary variable, respectively, and
the cost function includes following Equation (3) as a third constraint term:
$$\begin{matrix}[ Math . 3 ] & \\ {Q}_{3} = {\sum }_{t = 0}^{H - 1} {\{ {\sum }_{i = 0}^{U - 1} {P}_{max , i} {a}_{i}^{t , t} - {L}_{t} - {R}_{t} - [ {\sum }_{i = 0}^{U - 1} {P}_{max , i} - {L}_{t} - {R}_{t} ] ( {\sum }_{k = 1}^{F} {2}^{- k} {ψ}_{k}^{t} ) \}}^{2} & ( 3 )\end{matrix}$$
where H and U are the number of time frames and the number of power generating units, respectively,
t and i are indexes of one of the time frames and one of the power generating units, respectively,
aᵢ^{t,t} indicates either an ON state or an OFF state of the power generating unit with index i in the time frame with index t,
F is an integer equal to or more than 1,
k is an index,
Lₜ is a power demand in the time frame with index t,
P_{max,i} is maximum power generation of the power generating unit with index i, and
Rₜ is a spinning reserve in the time frame with index t.

5. The cost function generation device according to claim 1, wherein
the parameter information includes H, U, P_{max,i}, P_{min,i}, P_{up,i}, P_{down,i}, and F as parameters,
the plurality of binary variables include aᵢ^{t,t} and χ_{i,k}^{t} as second binary variable and a fourth binary variable, respectively, and
the cost function includes following Equation (4) as a fourth constraint term:
$$\begin{matrix}[ Math . 4 ] & \\ {Q}_{4} = {\sum }_{t = 1}^{H - 1} {\sum }_{i = 0}^{U - 1} {[ ( {P}_{max , i} - {P}_{min , i} ) ( {\sum }_{k = 1}^{N} {2}^{- k} ( {z}_{ik}^{t} - {z}_{ik}^{t - 1} ) ) + {P}_{min , i} ( {a}_{i}^{t , t} - {a}_{i}^{t - 1 , t - 1} ) - {P}_{up , i} + ( {P}_{up , i} + {P}_{down , i} ) {\sum }_{k = 1}^{F} {2}^{- k} {χ}_{i , k}^{t} ]}^{2} & ( 4 )\end{matrix}$$
where H and U are the number of time frames and the number of power generating units, respectively,
t and i are indexes of one of the time frames and one of the power generating units, respectively,
aᵢ^{t,t} indicates either an ON state or an OFF state of the power generating unit with index i in the time frame with index t,
F is an integer equal to or more than 1,
k is an index,
zᵢₖ^{t} is the first binary variable,
P_{max,i} and P_{min,i} are maximum power generation and minimum power generation of the power generating unit with index i, respectively, and
P_{up,i} and P_{down,i} are a power incremental limit value and a power decremental limit value of the power generating unit with index i, respectively.

6. The cost function generation device according to claim 1, wherein
the parameter information includes H, U, P_{max,i}, P_{min,i}, P_{up,i}, P_{down,i}, and F as parameters,
the plurality of binary variables include aᵢ^{t,t} and φ_{i,k}^{t} as a second binary variable and a fifth binary variable, respectively, and
the cost function includes following Equation (5) as a fifth constraint term:
$$\begin{matrix}[ Math . 5 ] & \\ {Q}_{5} = {\sum }_{t = 0}^{H - 1} {\sum }_{i = 0}^{U - 1} {[ ( {P}_{max , i} - {P}_{min , i} ) ( {\sum }_{k = 1}^{N} {2}^{- k} ( {z}_{i k}^{t} - {z}_{i k}^{t - 1} ) ) + {P}_{min , i} ( {a}_{i}^{t , t} - {a}_{i}^{t - 1 , t - 1} ) + {P}_{down , i} - ( {P}_{up , i} + {P}_{down , i} ) {\sum }_{k = 1}^{F} {2}^{- k} {ϕ}_{i , k}^{t} ]}^{2} & ( 5 )\end{matrix}$$
where H and U are the number of time frames and the number of power generating units, respectively,
t and i are indexes of one of the time frames and one of the power generating units, respectively,
aᵢ^{t,t} indicates either an ON state or an OFF state of the power generating unit with index i in the time frame with index t,
F is an integer equal to or more than 1,
k is an index,
zᵢₖ^{t} is the first binary variable,
P_{max,i} and P_{min,i} are maximum power generation and minimum power generation of the power generating unit with index i, respectively, and
P_{up,i} and P_{down,i} are a power incremental limit value and a power decremental limit value of the power generating unit with index i, respectively.

7. The cost function generation device according to claim 1, wherein
the parameter information includes H, U, T_{min,on,i}, T_{on,i}⁻¹, and G as parameters,
the plurality of binary variables include aᵢ^{t,t2} and η_{i,j}^{t} as a sixth binary variable and a seventh binary variable, respectively, and
the cost function includes following Equation (6) as a sixth constraint term:
$$\begin{matrix}[ Math . 6 ] & \\ {Q}_{6} = {\sum }_{i = 0}^{U - 1} {[ ( {a}_{i}^{- 1 , - 1} - {a}_{i}^{0 , 0} ) ( {T}_{on , i}^{- 1} - {T}_{min , on , i} ) - {\sum }_{j = 0}^{G - 1} {2}^{j} {η}_{i , j}^{0} ]}^{2} + {\sum }_{i = 0}^{U - 1} {\sum }_{t = 1}^{H - 1} {\{ [ {\sum }_{{t}_{2} = 0}^{t - 1} ( {a}_{i}^{t - 1 , {t}_{2}} - {a}_{i}^{t , {t}_{2}} ) ] + ( {a}_{i}^{t - 1 , 0} - {a}_{i}^{t , 0} ) {T}_{on , i}^{- 1} - ( {a}_{i}^{t - 1 , t - 1} - {a}_{i}^{t , t} ) {T}_{min , on , i} - {\sum }_{j = 0}^{G - 1} {2}^{j} {η}_{i , j}^{t} \}}^{2} & ( 6 )\end{matrix}$$
where H and U are the number of time frames and the number of power generating units, respectively,
t and t2 are indexes of ones of the time frames,
i is an index of one of the power generating units,
aᵢ^{t,t2} indicates a product of ON or OFF states of the power generating unit with index i in the respective time frames after the time frame with index t2 and before the time frame with index t,
G is an integer equal to or more than 1,
j is an index,
T_{min,on,i} is a minimum uptime of the power generating unit with index i, and
T_{on,i}⁻¹ is a continuous uptime period of the power generating unit with index i in the time frames with an index being zero.

8. The cost function generation device according to claim 7, wherein
the cost function includes following Equation (7) as a seventh constraint term:
$$\begin{matrix}[ Math . 7 ] & \\ {Q}_{7} = {\sum }_{0 \leq {t}_{2} < {t}_{1} < H} {{\sum }^{U - 1}}_{i = 0} [ {a}_{i}^{{t}_{1} , {t}_{1}} {a}_{i}^{{t}_{1} - 1 , {t}_{2}} - 2 ( {a}_{i}^{{t}_{1} , {t}_{1}} + {a}_{i}^{{t}_{1} - 1 , {t}_{2}} ) {a}_{i}^{{t}_{1} , {t}_{2}} + 3 {a}_{i}^{{t}_{1} , {t}_{2}} ] & ( 7 )\end{matrix}$$
where t1 is an index of one of the time frames,
aᵢ^{t1,t1} indicates either an ON state or an OFF state of the power generating unit with index i in the time frame with index t1,
aᵢ^{t1-1,t2} indicates a product of ON or OFF states of the power generating unit with index i in the respective time frames after the time frame with index t2 and before a time frame with index t1-1, and
aᵢ^{t1,t2} indicates a product of ON or OFF states of the power generating unit with index i in the respective time frames after the time frame with index t2 and before the time frame with index t1.

9. The cost function generation device according to claim 1, wherein
the parameter information includes P_{max,i} and P_{min,i} as parameters,
the plurality of binary variables include aᵢ^{t,t} as a second binary variable, and
the amount of power generation is expressed in following Formula (8):
$$\begin{matrix}[ Math . 8 ] & \\ ( {P}_{max , i} - {P}_{min , i} ) ( {\sum }_{k = 1}^{N} {2}^{- k} {z}_{i k}^{t} ) + {P}_{min , i} {a}_{i}^{t , t} & ( 8 )\end{matrix}$$
where t and i are indexes of one of the time frames and one of the power generating units, respectively,
aᵢ^{t,t} indicates either an ON state or an OFF state of the power generating unit with index i in the time frame with index t,
k is an index,
zᵢₖ^{t} is the first binary variable, and
P_{max,i} and P_{min,i} are maximum power generation and minimum power generation of the power generating unit with index i, respectively.

10. The cost function generation device according to claim 1, wherein
the parameter information includes H, U, T_{min,off,i}, T_{off,i}⁻¹, and G as parameters,
the plurality of binary variables include bᵢ^{t,t2} and γ_{i,j}^{t} as an eighth binary variable and a ninth binary variable, and
the cost function includes following Equation (9) as an eighth constraint term:
$$\begin{matrix}[ Math . 9 ] & \\ {Q}_{8} = {\sum }_{i = 0}^{U - 1} {[ ( {b}_{i}^{- 1 - 1} - {b}_{i}^{0 , 0} ) ( {T}_{off , i}^{- 1} - {T}_{min , off , i} ) - {\sum }_{j = 0}^{G - 1} {2}^{j} {γ}_{i , j}^{0} ]}^{2} + {\sum }_{i = 0}^{U - 1} {\sum }_{t = 1}^{H - 1} {\{ [ {\sum }_{{t}_{2} = 0}^{t - 1} ( {b}_{i}^{t - 1 , {t}_{2}} - {b}_{i}^{t , {t}_{2}} ) ] + ( {b}_{i}^{t - 1 , 0} - {b}_{i}^{t , 0} ) {T}_{off , i}^{- 1} - ( {b}_{t}^{t - 1 , t - 1} - {b}_{i}^{t , t} ) {T}_{min , off , i} - {\sum }_{j = 0}^{G - 1} {2}^{j} {γ}_{1 , j}^{t} \}}^{2} & ( 9 )\end{matrix}$$
where H and U are the number of time frames and the number of power generating units, respectively,
t and t2 are indexes of ones of the time frames,
i is an index of one of the power generating units,
bᵢ^{t,t2} indicates a product of ON or OFF states of the power generating unit with index i in the respective time frames after the time frame with index t2 and before the time frame with index t,
G is an integer equal to or more than 1,
j is an index,
T_{min, off,i} is a minimum downtime of the power generating unit with index i, and
T_{off,i}⁻¹ is a continuous downtime period of the power generating unit with index i in the time frames with an index being zero.

11. The cost function generation device according to claim 10, wherein
the cost function includes following Equation (10) as a ninth constraint term:
$$\begin{matrix}[ Math . 10 ] & \\ {Q}_{9} = {\sum }_{0 \leq {t}_{2} < {t}_{1} < H} {\sum }_{i = 0}^{U - 1} [ {b}_{i}^{{t}_{1} , {t}_{1}} {b}_{i}^{{t}_{1} - 1 , {t}_{2}} - 2 ( {b}_{i}^{{t}_{1} , {t}_{1}} + {b}_{i}^{{t}_{1} - 1 , {t}_{2}} ) {b}_{i}^{{t}_{1} , {t}_{2}} + 3 {b}_{i}^{{t}_{1} , {t}_{2}} ] & ( 10 )\end{matrix}$$
where t1 is an index of one of the time frames,
bᵢ^{t1,t1} indicates either an ON state or an OFF state of the power generating unit with index i in the time frame with index t1,
bᵢ^{t1-1,t2} indicates a product of OFF or ON states of the power generating unit with index i in the respective time frames after the time frame with index t2 and before a time frame with index t1-1, and
bᵢ^{t1,t2} indicates a product of OFF or ON states of the power generating unit with index i in the respective time frames after the time frame with index t2 and before the time frame with index t1.

12. The cost function generation device according to claim 7, wherein
the plurality of binary variables include bᵢ^{t,t} as a tenth binary variable, and
the cost function includes following Equation (11) as a tenth constraint term:
$$\begin{matrix}[ Math . 11 ] & \\ {Q}_{10} = {\sum }_{t = 0}^{H - 1} {\sum }_{i = 0}^{U - 1} {[ {a}_{i}^{t , t} + {b}_{i}^{t , t} - 1 ]}^{2} & ( 11 )\end{matrix}$$
where aᵢ^{t,t} indicates either an ON state or an OFF state of the power generating unit with index i in the time frame with index t, and
bᵢ^{t,t} indicates either the ON state or the OFF state of the power generating unit with index i in the time frame with index t.

13. A processing device comprising:
the cost function generation device according to claim 1; and
a quantum computer unit that optimizes the plurality of binary variables to reduce costs based on the cost function.

14. A cost function generation method for a cost function generation device comprising:
acquiring parameter information including N (an integer equal to or more than 1) as a parameter; and
generating, based on the parameter information, a cost function including a plurality of binary variables for calculating a unit commitment schedule for a plurality of power generating units over a plurality of consecutive time frames by quadratic unconstrained binary optimization, wherein
the cost function includes an amount of power generation in each of the time frames and each of the power generating units,
the plurality of binary variables include N first binary variables in each of the time frames and each of the power generating units, and
the amount of power generation is expressed using any one of 2^{N} patterns with the N first binary variables.

15. A processing device comprising a quantum computer unit that optimizes the plurality of binary variables so that costs based on the cost function generated by the cost function generation method according to claim 14 are reduced.

16. A cost function generation program used in a cost function generation device, the cost function generation program causing a computer to function as:
a parameter information acquisition unit that acquires parameter information including N (an integer equal to or more than 1) as a parameter; and
a function generation unit that generates, based on the parameter information, a cost function including a plurality of binary variables for calculating a unit commitment schedule for a plurality of power generating units over a plurality of consecutive time frames by quadratic unconstrained binary optimization, wherein
the cost function includes an amount of power generation in each of the time frames and each of the power generating units,
the plurality of binary variables include N first binary variables in each of the time frames and each of the power generating units, and
the amount of power generation is expressed using any one of 2^{N} patterns with the N first binary variables.
